(19) United States
(12) Patent Application Publication
(10) Pub. No.: US 2011/0174152 A1
(43) Pub. Date: Jul. 21, 2011

(54) VALVE-CONTROLLED POSITIVE DISPLACEMENT MACHINE

(76) Inventors: Karsten MISCHKER, Leonberg (DE); Joerg Weingart, Horb (DE); Rainer Walter, Pleidelsheim (DE); Peter Schwaderer, Wildberg (DE)

(21) Appl. No.: 13/007,041

(22) Filed: Jan. 14, 2011

(30) Foreign Application Priority Data
Jan. 18, 2010 (DE) 10 2010 004 808.9

(51) Int. Cl. F15B 13/04

(52) U.S. Cl. 91/418

(57) ABSTRACT

A valve-controlled hydrostatic positive displacement machine (DDU) is proposed, with a plurality of cylinder-piston units which are each activatable or deactivatable, via at least one low-pressure valve and via one high-pressure valve, for adjusting a volume flow of the positive displacement machine. According to the invention a valve body of the high-pressure valve is embodied as a valve slide, and operative faces acted upon in or counter to a displacement direction are essentially pressure-balanced.

### CROSS-REFERENCE TO RELATED APPLICATION

This application is based on German Patent Application 10 2010 004 808.9 filed on Jan. 18, 2010.

### BACKGROUND OF THE INVENTION

1. Field of the Invention

The invention relates to a valve-controlled positive displacement machine.

2. Description of the Prior Art

In conventional positive displacement machines, which can be embodied for instance as radial piston or axial piston engines, the control of the inflow and outflow, or of the connections with the high and low pressure of the individual cylinder-piston units, is effected mechanically. In the case of an axial piston pump, for instance, two pressure pockets are used, by way of which the communications with the high-pressure side and the low-pressure side open during a certain range of the circular path and thus during a certain portion of the stroke of the cylinder-piston units. In radial piston pumps, one mechanical high-pressure valve and one mechanical low-pressure valve are provided per cylinder-piston unit. The high-pressure valve for each unit opens for instance every time a certain built-up pressure in the particular cylinder is exceeded, so that the pressure-elevated pressure fluid can flow away to the high-pressure side of the pump.

In such hydrostatic positive displacement machines, it is disadvantageous that all the cylinder-piston units are always active.

International Patent Disclosure WO 2008/012558 A2 discloses valve-controlled positive displacement machines, so-called digital displacement units (DDUs), in which each cylinder-piston unit is assigned one electrically actuated low-pressure valve and one electrically actuated high-pressure valve.

Thus the units are triggerable separately in the pumping mode, the motor mode, and a so-called idling mode. By means of the idling mode, individual units can be deactivated or switched to be forceless by means of long-term opening of the low-pressure valve and long-term closure of the high-pressure valve. Thus it is possible to reduce the volume flow or rpm of the positive displacement machine.

International Patent Disclosure WO 2008/029073 A1 shows a 4-quadrant DDU (motor, pump, rotating counterclockwise, rotating clockwise) with a high-pressure valve that has a check function (for the pumping mode) and a switching function (for the motor mode). For it to be capable of operating in the pumping mode, a pressure difference from the cylinder to the high-pressure side of the positive displacement machine must lead to opening of the high-pressure valve. Especially if the pressure of the high-pressure side is significantly above that of the cylinder, a high closing force acts on the valve body of the high-pressure valve, and this force has to be overcome in the motor mode. For that case, before the high-pressure valve is switched, a pressure equilibrium is established via an auxiliary valve (for instance, via a pilot control needle in the high-pressure valve).

A disadvantage of such valve-controlled positive displacement machines is the cross-sectional area, which is restricted by the magnetic force of the pilot control needle. To make a pressure equilibrium in operation possible, both the compression volume and the pressure fluid which is required because of the change in volume of the rotating pump must be supplied via the pilot control needle. With increasing pump rpm, both the cross-sectional area made available by the pilot control needle and the maximum possible pressure fluid volume flow for the pressure equilibrium are therefore limited.

### OBJECT AND SUMMARY OF THE INVENTION

By comparison, it is the object of the invention to create a valve-controlled positive displacement machine which with reduced circuitry expense in terms of apparatus makes increased volume flows through the high-pressure valve possible.

This object is attained by a valve-controlled positive displacement machine according to the invention.

The valve-controlled hydrostatic positive displacement machine (DDU) according to the invention has a plurality of cylinder-piston units which are each activatable or deactivatable, via at least one low-pressure valve and via one high-pressure valve, for adjusting a volume flow of the positive displacement machine. A valve body of the high-pressure valve is embodied according to the invention as a valve slide, and operative faces acted upon in or counter to a displacement direction are essentially pressure-balanced. Thus a high-pressure valve for a DDU is created which can be switched with less switching force and thus with less apparatus expense, without requiring prior pressure relief of the valve body. Comparatively large volume flows through the high-pressure valve are then possible, with a comparatively smaller switching force.

In an especially preferred refinement, the operative faces are essentially circular or annular and, acting in pairs in and counter to the displacement direction, are approximately of equal size. The result is a largely cylindrical valve slide that is simple to manufacture. Moreover, the pressure forces of the paired operative faces in pressure equilibrium acting on the valve slide are equalized.

In an especially preferred exemplary embodiment, parallel to the high-pressure valve, a spring-loaded check valve is provided, whose opening direction is oriented from the cylinder toward a high-pressure port of the positive displacement machine. Thus one additional flow path is created, which in the pumping mode of the positive displacement machine of the invention, when a predetermined pressure in the cylinder is reached, can be opened toward the high-pressure port of the pump automatically and independently of the high-pressure valve.

In an especially preferred refinement, a valve housing of the high-pressure valve has a valve bore, with two pressure chambers spaced apart in the displacement direction, of which one pressure chamber communicates with the high-pressure port of the positive displacement machine and the other communicates with the cylinder; a communication of the pressure chambers is controllable via a radially stepped-back region by way of which the two pressure chambers can be made to communicate. The radially stepped-back region is defined by two annular operative faces. The operative faces are disposed essentially perpendicular to the displacement direction and are of equal size. As a result, they are acted upon either together by the pressure of one pressure chamber or by the pressure of the other pressure chamber, or by the pressure of the two communicating pressure chambers, and are thus force-balanced.

Preferably, the switching of the high-pressure valve is effected by providing that a spring engages a first end face of the valve slide, while a second end face of the valve slide is connected to an armature of a solenoid, and both end faces are in pressure equilibrium.

In an especially preferred exemplary embodiment, the valve slide controls the low-pressure valve as well. The high-pressure valve and the low-pressure valve are disposed in a common 3/2-way valve housing, which has a high-pressure port, a low-pressure port, and a port to the cylinder. Thus the construction of the high-pressure valve and of the low-pressure valve per cylinder of the positive displacement machine of the invention is simplified.

In a preferred refinement of the common multiposition valve, the valve slide has two radially stepped-back regions, by way of which the ports can be made to communicate, and the radially stepped-back regions are each defined by two annular operative faces which are disposed essentially perpendicular to the displacement direction and are of equal size. As a result, the operative faces are acted upon in pairs, either together by the pressure of the high-pressure port or the low-pressure port, or of the port to the cylinder, and are thus in force equilibrium.

In a preferred refinement, in a basic position, prestressed by a spring, of the valve slide the low-pressure port communicates with the port to the cylinder, while the high-pressure port is blocked. In a switching position of the valve slide, the high-pressure port communicates with the port to the cylinder, while the low-pressure port is blocked.

Preferably, the switching of the common multiposition is effected by providing that the valve slide is displaceable into its switching position by a solenoid or a pilot control valve or via a cam.

To achieve a force equilibrium at the terminal portions of the valve slide, it is preferred in, accordance with one exemplary embodiment of the invention if the valve slide has two end faces of equal size, which are acted upon by the same pressure, in particular the tank or ambient pressure.

Especially good sealing off of the high-pressure port is achieved if, in another exemplary embodiment of the invention, the valve slide, between the high-pressure port and the port to the cylinder, has a valve seat, which is closable by a conical closing portion of the valve slide.

In order to achieve a force equilibrium at the terminal portions of the valve slide, the valve slide has an axial through bore for connecting two end faces in which pressure prevails.

In an advantageous refinement of all the exemplary embodiments, the valve housing is integrated with a housing of the positive displacement machine.

The invention will be better understood and further objects and advantages thereof will become more apparent from the ensuing detailed description of preferred embodiments taken in conjunction with the drawings.

### BRIEF DESCRIPTION OF THE DRAWINGS

FIG. 1 is a circuit diagram of a cylinder-piston unit of a positive displacement machine according to the invention, having a valve arrangement, in accordance with a first exemplary embodiment;

FIG. 2 shows a high-pressure valve in the first exemplary embodiment in section;

FIG. 3 shows a cylinder-piston unit of a positive displacement machine of the invention, with a combined high- and low-pressure valve, in accordance with a second exemplary embodiment, in a schematic section;

FIG. 4 is a circuit diagram of the combined valve in the second exemplary embodiment;

FIG. 5 shows a cylinder-piston unit of a positive displacement machine of the invention, with a combined high- and low-pressure valve, in accordance with a third exemplary embodiment, in a schematic section; and

FIG. 6 shows a variant of a valve slide of a combined valve in accordance with the third exemplary embodiment, in a perspective view.

### DESCRIPTION OF THE PREFERRED EMBODIMENTS

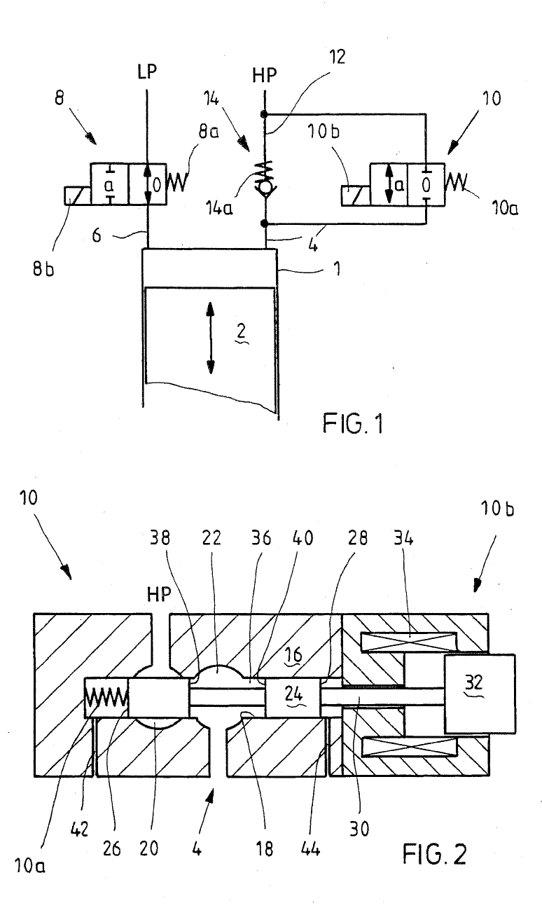

FIG. 1 shows a circuit diagram of a cylinder-piston unit of a positive displacement machine according to the invention that has a plurality of such units, each having a cylinder 1, and a piston 2. Each cylinder 1 communicates with a high-pressure port HP of the positive displacement machine of the invention via a high-pressure line 4 and with a low-pressure port LP via a low-pressure line 6.

The communication with the low-pressure port LP is controlled via a low-pressure valve 8, and the communication with the high-pressure port HP is controlled via a high-pressure valve 10. The low-pressure valve 8, in a basic position 0 prestressed by a spring 8a, enables the communication with the cylinder 1, while in a switching position a switched by an actuator 8b, it blocks the cylinder 1. The high-pressure valve 10, in a basic position 0 prestressed by a spring 10a, blocks the cylinder 1, while in a switching position a switched by an actuator 10b, it enables the communication with the cylinder 1.

In a high-pressure line 12, parallel to the high-pressure valve 10, a check valve 14 prestressed by a spring 14a is provided, whose opening direction is oriented from the cylinder 1 to the high-pressure port HP of the positive displacement machine.

The check valve 14 acting as a bypass valve can also be advantageous without a pressure equilibrium.

FIG. 2 shows the high-pressure valve 10 of FIG. 1 in section. It has a valve housing 16 with a valve bore 18. In the valve bore 18, a pressure chamber 20 connected to the high pressure of the positive displacement machine, and a pressure chamber 22, communicating with the cylinder 1 via the high-pressure line 4, are provided. In the valve bore 18, a valve slide 24 is disposed, whose left-hand (in FIG. 2) end face 26 is engaged by the compression spring 10a, which is braced on the valve housing 16 and prestresses the valve slide 24 into its right-hand (as shown in FIG. 2) closing position. On the right-hand (in FIG. 2) end face 28 of the valve slide 24, an armature 32 of the actuator 10b, embodied as a solenoid, is secured via a connecting portion 30. The armature is displaceable to the left (in FIG. 2) when current is supplied to a coil 34.

The valve slide 24 has a radially stepped-back region 36, by way of which pressure fluid from the high-pressure port HP can flow to the high-pressure line 4 or to the cylinder 1, when the valve slide 24 is displaced by the actuator 10b toward the left (in FIG. 2) into its switching position, counter to the force of the spring 10a. The radially stepped-back region 36 is defined by two annular operative faces 38, 40, whose outside diameters are approximately equivalent to the diameter of the valve slide 24 and approximately equivalent to the diameter of the valve bore 18. The operative face 38 is surrounded by a control edge, by way of which a volume flow of pressure fluid is controllable.

In the basic position, shown, of the valve slide 24, the two operative faces 38, 40 are subjected to the prevailing pressure in the cylinder 1, while in the switching position of the valve slide 24 they are subjected to high pressure. Thus the two operative faces 38, 40 are in pressure equilibrium and in force equilibrium according to the invention.

The two end faces 26, 28 are subjected, each via a respective leakage line 42, 44, by ambient or tank pressure and are thus likewise in pressure equilibrium.

According to the invention, the valve slide 24 is thus switchable with only slight force, even if there is a great pressure difference between the high-pressure port HP and the cylinder 1, or the high-pressure line 4, without requiring a prior pressure equilibrium. For the switching, essentially only the spring force of the spring 10a has to be overcome.

In the pumping mode of the positive displacement machine of the invention, the check valve 14 (see FIG. 1) connected parallel to the high-pressure valve 10 enables an expulsion of the pressure fluid from the cylinder 1 during a positive displacement stroke of the piston 2, when the pressure in the cylinder 1 is higher than the pressure of the high-pressure port HP of the displacement pump by the equivalent of the pressure of the spring 14a. For a pumping mode, basically the cyclically opening check valve 14 suffices, and at some operating points, an additional opening of the high-pressure valve 10 can further improve the efficiency of the displacement pump. Or, the high-pressure valve 10 in pressure equilibrium can be dispensed with, to reduce the equipment expense for the displacement pump.

The 4-quadrant positive displacement machine (motor, pump, rotating counterclockwise, rotating clockwise) according to the invention, of which in FIG. 1 only a cylinder-piston unit 1, 2 is shown as an example, has optimized partial-load efficiency. It can be utilized in vehicles for constructing a variable hydraulic transmission and for using braking energy by hydraulic recuperation, for the start-stop function and to save fuel.

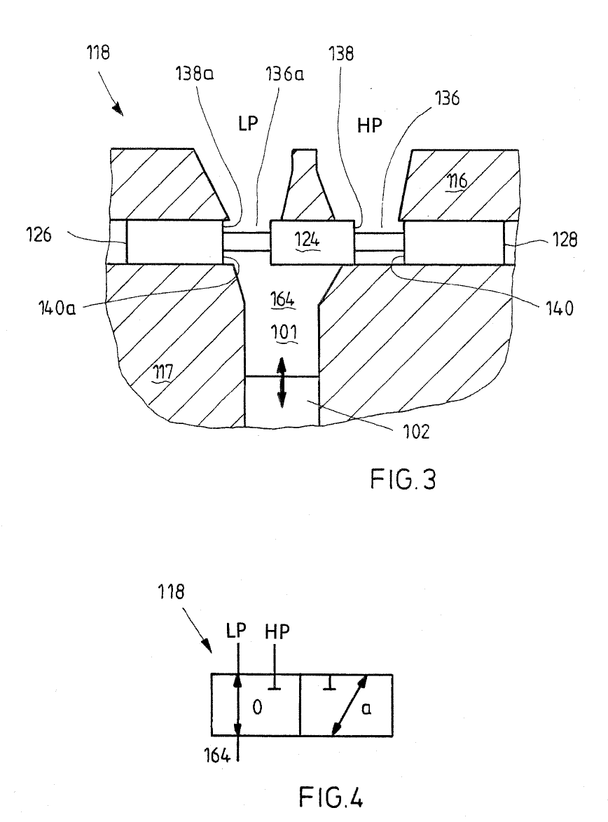

FIG. 3, in a schematic view, shows a cylinder-piston unit of a positive displacement machine of the invention, in a second exemplary embodiment, having a cylinder 101, and a piston 102. In it, the entire volume flow of pressure fluid to and from the cylinder 101 travels via a 3/2-way valve 118, in which the communication of the low-pressure port LP of the positive displacement machine with the cylinder 101 and the communication of the high-pressure port HP of the positive displacement machine with the cylinder 101 are controlled via a common valve slide 124.

A housing 116 of the 3/2-way valve 118 is integrated with a housing 117 of the positive displacement machine of the invention. The multiposition valve 118 has a high-pressure port HP, a low-pressure port LP, and a single connection 164 from the multiposition valve 118 to the cylinder 101.

In the schematic drawing in FIG. 3, the size ratios between the multiposition valve 118, the connection 164, and the cylinder-piston unit are not shown to scale.

The valve slide 124 has two radially stepped-back regions 136a, 136, and the region 136a serves to connect the low-pressure port LP to the cylinder 101, and the region 136 serves to connect the high-pressure port to the cylinder 101. The stepped-back region 136 is defined by two annular operative faces 138, 140, oriented perpendicular to the displacement direction of the valve slide 124 and counter to one another, while the stepped-back region 136a is defined by corresponding operative faces 138a, 140a. Also, on its end portions, the valve slide 124 has one end face 126, 128 each, which are approximately of equal size and are acted upon by the same pressure (such as tank or ambient pressure).

The four operative faces 138, 140, 138a, 140a are likewise approximately of equal size, and the two operative faces 138, 140 are always subjected to high pressure, while the two operative faces 138a, 140a are always subjected to low pressure. Thus according to the invention the valve slide 124 is pressure- and force-balanced, so that it can be displaced with comparatively slight force by means of a solenoid or a pilot control valve or via a cam (not shown), without requiring a pressure equilibrium.

Moreover, the apparatus expense is reduced by the combination of the high-pressure valve and the low-pressure valve in the common 3/2-way valve 118 per cylinder-piston unit.

FIG. 4 shows a circuit diagram of the 3/2-way valve 118 in the second exemplary embodiment of FIG. 3, with the valve slide 124 in its basic position 0 (also shown in FIG. 3). The cylinder 101 communicates with the low-pressure port LP of the positive displacement machine via the connection 164, while the communication with the high-pressure port HP is blocked. In this basic position 0, the cylinder-piston unit can either replenish pressure fluid in the pumping mode or expel expanded pressure fluid in the motor mode. By means of long-term switching of the valve slide 124 to the basic position 0, the corresponding cylinder-piston unit would be switched to a hydraulic idle (idling mode).

In a switching position a, the cylinder 101 communicates with the high-pressure port HP of the positive displacement machine via the connection 164, while the low-pressure port LP is blocked. In this switching position a, the corresponding cylinder-piston unit functions either by expelling pressure fluid at high pressure in the pumping mode or by being subjected to pressure fluid at high pressure, and transmits the energy via the piston 102 to a power takeoff shaft (not shown) of the positive displacement machine.

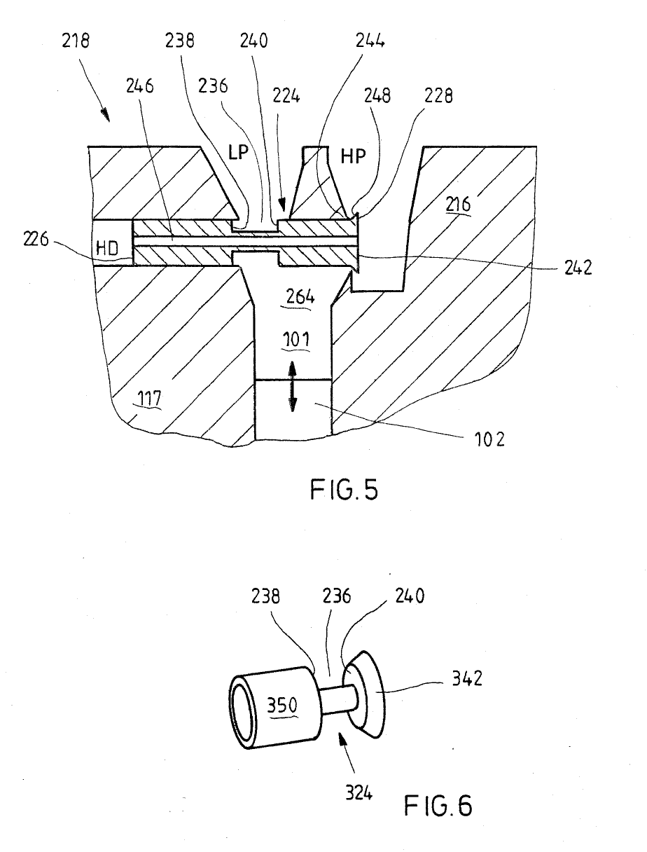

FIG. 5 shows a cylinder-piston unit having a cylinder 101 and a piston 102, with a combined 3/2-way valve 218, in a third exemplary embodiment, in a schematic section. Below, only the differences in the third exemplary embodiment compared to the second exemplary embodiment (see FIG. 3) will be described.

The communication between the high-pressure port HP and the cylinder 101 is controlled not via a radially stepped-back region 136 but rather via a conical closing portion 242 and a corresponding valve seat 244 associated with it. The conical closing portion 242 is embodied on the right-hand end portion of the valve slide 224 in FIG. 5, and in the state shown it is pressed against the valve seat 244, so that the communication between the cylinder 101 and the high-pressure port HP of the positive displacement machine is blocked.

The valve slide 224 is penetrated by an axial through bore 246, as a result of which the high pressure, applied to a right-hand end face 228 (in FIG. 5) is also applied to the oppositely placed end face 226 of the valve slide 224. As a result, the two end faces 226, 228 are pressure-balanced, and because of a conical jacket face 248 of the closing portion 242, the two end portions of the valve slide 224 are in force equilibrium as well.

FIG. 6 shows a variant of a valve slide 324 compared to that of the third exemplary embodiment of FIG. 5 in a perspective view. Here, a guide portion shown in FIG. 5, disposed between the radially stepped-back region 236 and the conical closing portion 342, is omitted, so that the closing portion 342 is disposed immediately adjacent to the radially stepped-back region 236. In this case, the guidance of the valve slide 324 is effected via a guide portion 350.

The operative faces 238 here must be positioned on the respective valve slide 224, 324 in such a way (see FIGS. 5 and 6) that when the respective closing portion 242, 342 lifts from the valve seat 244, they close the pressure fluid connection from the low-pressure port LP to the connection 264 or to the cylinder 101.

A valve-controlled hydrostatic positive displacement machine (DDU) is proposed, with a plurality of cylinder-piston units which are each activatable or deactivatable, via at least one low-pressure valve and via one high-pressure valve, for adjusting a volume flow of the positive displacement machine. A valve body of the high-pressure valve is embodied according to the invention as a valve slide, and operative faces acted upon in or counter to a displacement direction are essentially pressure-balanced.

The foregoing relates to preferred exemplary embodiments of the invention, it being understood that other variants and embodiments thereof are possible within the spirit and scope of the invention, the latter being defined by the appended claims.

1. A valve-controlled hydrostatic positive displacement machine, having
a plurality of cylinder-piston units, which are each activatable or deactivatable via a low-pressure valve and via a high-pressure valve for adjusting a volume flow of the positive displacement machine,
a valve body of the high-pressure valve being embodied as a valve slide having operative faces, acted upon in or counter to a displacement direction, which faces are essentially in pressure equilibrium.

2. The positive displacement machine as defined by claim 1, wherein the operative faces are essentially circular or annular; and wherein operative faces, acting in pairs in and counter to the displacement direction, are approximately of equal size.

3. The positive displacement machine as defined by claim 1, wherein parallel to the high-pressure valve, a spring-loaded check valve is provided which has an opening direction oriented from the cylinder toward a high-pressure port of the positive displacement machine.

4. The positive displacement machine as defined by claim 2, wherein parallel to the high-pressure valve, a spring-loaded check valve is provided which has an opening direction oriented from the cylinder toward a high-pressure port of the positive displacement machine.

5. The positive displacement machine as defined by claim 1, wherein the valve slide is guided in a valve bore of a valve housing of the high-pressure valve; wherein two pressure chambers spaced apart in the displacement direction are embodied in the valve bore; and wherein one of the pressure chambers communicates with the high-pressure port of the positive displacement machine, and an other of the pressure chambers communicates with the cylinder.

6. The positive displacement machine as defined by claim 2, wherein the valve slide is guided in a valve bore of a valve housing of the high-pressure valve; wherein two pressure chambers spaced apart in the displacement direction are embodied in the valve bore; and wherein one of the pressure chambers communicates with the high-pressure port of the positive displacement machine, and an other of the pressure chambers communicates with the cylinder.

7. The positive displacement machine as defined by claim 3, wherein the valve slide is guided in a valve bore of a valve housing of the high-pressure valve; wherein two pressure chambers spaced apart in the displacement direction are embodied in the valve bore; and wherein one of the pressure chambers communicates with the high-pressure port of the positive displacement machine, and an other of the pressure chambers communicates with the cylinder.

8. The positive displacement machine as defined by claim 4, wherein the valve slide is guided in a valve bore of a valve housing of the high-pressure valve; wherein two pressure chambers spaced apart in the displacement direction are embodied in the valve bore; and wherein one of the pressure chambers communicates with the high-pressure port of the positive displacement machine, and an other of the pressure chambers communicates with the cylinder.

9. The positive displacement machine as defined by claim 5, wherein the valve slide has a radially stepped-back region, by way of which region a communication of the two pressure chambers is controllable and which region is defined by two annular operative faces, which are disposed essentially perpendicular to the displacement direction.

10. The positive displacement machine as defined by claim 9, wherein one of the operative faces is a first end face of the valve slide, which face is engaged by a spring; and wherein one of the operative faces is a second end face of the valve slide, which face is connected to an armature of a solenoid, and each end face is in pressure equilibrium.

11. The positive displacement machine as defined by claim 1, wherein the valve slide controls the high-pressure valve and the low-pressure valve, which are combined in a 3/2-way valve and are disposed in a common valve housing, and the 3/2-way valve has a high-pressure port, a low-pressure port, and a port to the cylinder.

12. The positive displacement machine as defined by claim 2, wherein the valve slide controls the high-pressure valve and the low-pressure valve, which are combined in a 3/2-way valve and are disposed in a common valve housing, and the 3/2-way valve has a high-pressure port, a low-pressure port, and a port to the cylinder.

13. The positive displacement machine as defined by claim 11, wherein the valve slide has two radially stepped-back regions, by way of which the port to the cylinder can be made to communicate to either the high-pressure port or the low-pressure port; and wherein the radially stepped-back regions are each defined by two annular operative faces, which are disposed essentially perpendicular to the displacement direction.

14. The positive displacement machine as defined by claim 12, wherein the valve slide has two radially stepped-back regions, by way of which the port to the cylinder can be made to communicate to either the high-pressure port or the low-pressure port; and wherein the radially stepped-back regions are each defined by two annular operative faces, which are disposed essentially perpendicular to the displacement direction.

15. The positive displacement machine as defined by claim 13, wherein in a basic position, prestressed by a spring, of the valve slide, the port to the cylinder communicates with the low-pressure port, while the high-pressure port is blocked; and wherein, in a switching position of the valve slide, the port to the cylinder communicates with the high-pressure port, while the low-pressure port is blocked.

16. The positive displacement machine as defined by claim 15, wherein the valve slide is actuatable by a solenoid or a pilot control valve or via a cam.

17. The positive displacement machine as defined by claim 11, wherein the valve slide has two operative faces, which are end faces of equal size, which are acted upon by the same pressure, in particular the tank or ambient pressure.

18. The positive displacement machine as defined by claim 11, wherein the valve slide, between the high-pressure port and the port to the cylinder, has a valve seat, which is closable by a conical closing portion of the valve slide.

19. The positive displacement machine as defined by claim 18, wherein the valve slide has an axial through bore for connecting two end faces which are acted upon by high pressure.

20. The positive displacement machine as defined by claim 5, wherein the valve housing is integrated with a housing of the positive displacement machine.
